(19) United States
(12) Patent Application Publication
(10) Pub. No.: US 2025/0217407 A1
(43) Pub. Date: Jul. 3, 2025

(54) MULTI-MODAL UTILITY ASSET SEARCHING

(71) Applicant: X Development LLC, Mountain View, CA (US)

(72) Inventor: Xin-Jing Wang, Mountain View, CA (US)

(21) Appl. No.: 18/971,727

(22) Filed: Dec. 6, 2024

Related U.S. Application Data
(60) Provisional application No. 63/615,743, filed on Dec. 28, 2023.

(51) Int. Cl. G06F 16/532; G06F 16/538

(52) U.S. Cl. CPC G06F 16/532; G06F 16/538

(57) ABSTRACT

This disclosure describes systems and methods for multi-modal search-based object detection and electric grid object search. Annotations and bounding boxes for images in an image database are determined. A first subset of images is determined from the images that share annotations. A textual token representing the first subset of images is generated and stored in a search index. A second subset of images that share visual features is determined from image pixels enclosed by the bounding boxes. An image token is generated based on the second subset of images and the shared visual features. A user interface configured to receive a search query input is provided for display on a user device. Search tokens are generated based on the search query input. A candidate image is identified and provided for display within the user interface at a position within a respective region of a geographic map of an electric grid.

### CROSS REFERENCE TO RELATED APPLICATIONS

This application is a non-provisional of and claims priority to U.S. Provisional Patent Application No. 63/615,743, filed on Dec. 28, 2023, the entire contents of which are hereby incorporated by reference.

### BACKGROUND

This disclosure generally relates to images of utility assets, including images capturing defects of utility assets.

Utility assets (e.g., transformers, network protectors, cables, utility poles, power stations, and substations) develop defects while distributing and transmitting power for an electrical grid. The utility assets perform complex functions to provide power from the electrical grid to loads at voltage and current levels suitable for residential, industrial, and commercial applications. Utility assets experience different types of defects (e.g., corrosion, wear and tear, environmental factors, and other types of physical damage), with varying impact to the performance and life cycle of the utility asset. Images of a particular utility asset can sometimes be captured during the lifecycle of the utility asset, e.g., by utility workers during inspections, maintenance, and other types of work performed on the utility asset. There is a growing interest in leveraging the images captured during field work to identify defects of utility assets to take preventative action to prevent operational failure of the utility asset.

### SUMMARY

This specification describes techniques that involve a system, and operations for a multi-modal search-based object detection system (also referred to as “a multi-modal search system”) for performing object detection and search of images of utility assets from an image database. The techniques include an offline stage for building a token-based search index for the images and an online stage for querying the search index to provide candidate images that match the query. The search index of the offline stage includes generating image tokens and textual tokens (collectively “the search tokens”) that group images of similar utility assets based on textual from object annotations and visual features from pixel data. The multi-modal search system generates tokens for groups of images based on similarities in asset type and defect status. The multi-modal search system can obtain queries for the search index through a user interface of a client device, and dynamically positions candidate images resulting from the query on the user interface. The candidate images can be positioned onto the user interface and dynamically overlaid onto a geographical map representing an electric map of utility assets.

As described in this specification, the multi-modal search system builds the search index by determining annotations and bounding boxes for each image in the image database. The annotations describe a type of utility asset, utility asset component, and/or defect status represented in the image, and the bounding boxes indicate regions of pixels in the image that enclose the indicated annotation. The multi-modal search system identifies a subset of images that share a common set of annotations for utility assets in the images, generates a textual token to represent and link the subset of images based on the annotations, and stores the textual token in the search index with unique identifiers for each image being stored in the textual token for retrieval. The multi-modal search system similarly identifies a subset of images based on a common set of visual features of utility assets in the images, generates an image token to represent and link the subset of images based on the visual features, encodes the visual features into token data for the image token, and stores the image token in the search index with unique identifiers for each image being stored in the textual token for retrieval.

The multi-modal search system permits for efficient and dynamic display of query results on a client device. The multi-modal search system receives input in the form of a search query, which may be a form of text and/or image data. Examples of input can include keywords, semantic search, images (with or without annotations), and bounding boxes for the images. The multi-modal search system utilizes an encoding of utility asset features (textual features, image features) from the search input to generate the search tokens. From the search index of images from an image database, the multi-modal search system identifies candidate images by comparing image tokens and textual tokens in the search index to the search tokens. Thus, the multi-modal search system allows for an identification of candidate images that share textual and/or visual features to the search input and provides the candidate images on the user interface of the client device. The user interface can display a geographical map of an electric grid and overlay a candidate image from the query results onto a position of the geographical map.

Particular embodiments of the subject matter described in this specification can be implemented to realize one or more of the following technical advantages. The multi-modal search system provides for multiple types of searches of utility assets and their defect statuses to be performed simultaneously and dynamically provisioned onto a user interface in near real-time. Examples of types of searches include keyword search, semantic search, image search, or some combination thereof. The multi-modal search system provides efficient search of images text tokens from features of object annotations that match a textual input, image input, or some combination thereof. The tokens can be generated by machine learning networks that utilize text and/or visual encoders to perform embeddings of the images, thereby storing the features of the utility assets in a lower dimensional space of the tokens rather than the representation of the features in the original images.

As an example, the lower dimensional representations from utilization of tokens allow for reduced computational loads and resources consumed by client devices, platforms, and other computing devices that access image databases, submit search queries, etc. The reduced space utilized by token-based image search also allows for indexing of images with similar features for utility asset type and defect status, so that the images are accurately grouped together. The multi-modal search system allows for a holistic identification and retrieval of candidate images in response to a search query, compared to approaches that simply search an image database. Furthermore, the architecture of the multi-modal search system allows for integration with utility asset databases, by retrieving and providing data for utility assets captured in a candidate image to the user interface of the client device.

The multi-modal search system allows for an efficient, multi-faceted search result for queries of utility assets that improve detectability of similar asset types and failures. In particular, the improved identification of utility assets by their object classification and defect status allows for prioritization of severely defective equipment and prevents unintentional power interruptions, damage to electrical utility assets, and other hazards caused by electrical power failure. Thus, the multi-modal search system improves the likelihood that preventative actions can be performed to address defects of the utility assets and provides analysis of electrical asset utility failures with an approach to responsively address the defective assets. In some cases, this allows analysts to identify similarly defective assets and develop roll-out measures to utilize the same equipment rehabilitation measures for the similarly grouped assets, e.g., reducing extraneous dispatch of equipment crews and increasing the likelihood of addressing all utility assets of a similar type and defect. Further still, the techniques described in this specification allow for the display of the candidate images to the client device to be overlaid on a geographical map of the electric grid, which can be used to model the electrical grid in a way that is more readily accessible to electric grid operators and analysts.

These and other embodiments can each optionally include one or more of the following features.

In an aspect, multi-modal search-based object detection method includes determining, for each image from a database of images, one or more annotations and one or more bounding boxes. Each annotation is descriptive of a type of utility asset depicted in a respective image and bounded by a particular bounding box, and each bounding box of the one or more bounding boxes encloses a region of image pixels of a respective image that contains at least a portion of a particular utility asset depicted in the respective image. The method includes determining, based on the annotations, a first subset of images from the images that share one or more annotations, and generating, based on the first subset of images and the shared one or more annotations, a textual token representing the first subset of images. The method includes storing the textual token in a search index. The textual token includes a first set of utility asset features representative of the annotations shared by each image in the first subset of images and a corresponding identifier for each image in the first subset of images. The method includes determining, based on the image pixels enclosed by the bounding boxes, a second subset of images from the images that share visual features associated with respective utility assets depicted in the respective images. The method includes generating, based on the second subset of images and the shared visual features, an image token representing the second subset of images and storing the image token in the search index.

The image token can include an image embedding encoding shared visual features and a corresponding identifier for each image in the second subset of images.

In some implementations, at least one image is included in both the second subset of images and the first subset of images. In some implementations, the textual token is generated by a machine learning network that includes a text transformer encoder configured to generate textual embeddings from a clustering of the first set of utility asset features representative of the annotations. The image token can be generated by a machine learning network that includes a vision transformer encoder configured to generate image embeddings from a clustering of the shared visual features. In some implementations, the utility asset is at least one of a utility pole, a transformer, or a wire.

In an aspect, a multi-modal electric grid object search method includes providing, for display on a user device, a user interface configured to receive input representing a search query for one or more images depicting an electric grid asset. The user interface can permit the input to include at least one of textual data or image data requesting the search query. The method includes, responsive to receiving a particular search input from the user interface, generating one or more search tokens dependent on whether the particular search input comprises textual data, image data, or both, each of the one or more search tokens encoding utility asset features represented by the particular search input. The method includes identifying a set of candidate images responsive to the particular search input from a database of images depicting electric grid assets. Identifying the set of candidate images includes comparing the search tokens with textual tokens and image tokens stored in a search index, each textual token representing textual descriptions of utility asset features shared by a respective subset of the images within the database, and each image token representing visual features shared by utility assets depicted in a respective subset of the images within the database. The method includes providing, for display on the user device and within the user interface, the candidate images and positioning at least one candidate image within a respective region of a geographic map of an electric grid that is representative of a geographic location of a particular electrical asset depicted in the at least one candidate image.

In some implementations, the one or more search tokens are generated by a machine learning network configured to encode the utility asset features from the particular search input.

The machine learning network includes at least one of (i) a text transformer encoder configured to generate textual embeddings from a clustering of the textual data or (ii) a vision transformer encoder configured to generate image embeddings from a clustering of the image data. In some implementations, the method further includes responsive to receiving the particular search input and the particular search input including textual data: obtaining a representative image relevant to the search input and providing the representative image for display in the user interface and, as additional textual data is received from the user interface, identifying, based on the additional textual data, an object within the representative image corresponding to the additional textual data and providing graphical representations of bounding boxes to surround pixels representing the object within the representative image. In some implementations, the particular search input includes image data, and the representative image relevant to the search input includes at least one image from the image data. In some implementations, the search tokens are generated using a first machine learning model. At least one of the textual tokens, the image tokens, or both can be generated using a second machine learning model, and the first machine learning model can be a lightweight model relative to the second machine learning model.

In some implementations, the method includes obtaining, by one or more scripts and from a data store, utility asset inventory data, updating, using the data related to the utility asset, the textual tokens and the image token stored in the search index. In some implementations, the utility asset inventory data includes at least one of a quantity of the particular electrical asset for the geographic location, or a quantity of a defect type for the particular electrical asset.

In some implementations, the method further includes filtering, based on the textual token and the image token for the input, the images to obtain a filtered subset of images. The filtered subset of images can exclude images that do not include at least one token from the textual token and the image token corresponding to the input that match, from the search index, the textual token and the image token. The method further includes determining, based on the textual token and the image token, a similarity score for each image in the filtered subset of images, the similarity score indicates a likelihood of a respective image matching the textual token and the image token. The method further includes identifying the candidate images from the filtered subset of images, the candidate images each having a respective similarity score that exceeds a threshold value. In some implementations, the method further includes ranking the candidate images based on the similarity score of the respective candidate image.

In some implementations, the method further includes determining that the input includes the textual data, and in response to determining that the input includes the textual data, generating the one or more search tokens based on utility asset features from the textual data and comparing the one or more search tokens based on the textual data to the textual tokens of the search index.

In some implementations, the method further includes determining that the input includes the image data, and in response to determining that the input includes the image data, generating the one or more search tokens based on the utility asset features from the image data and comparing the one or more search tokens based on the image data to the image tokens of the search index.

In an aspect, a system for multi-modal electric grid object search includes one or more computers and one or more storage devices storing instructions that are operable, when executed by the one or more computers, to cause the one or more computers to perform operations. The operations include providing, for display on a user device, a user interface configured to receive input representing a search query for one or more images depicting an electric grid asset, where the user interface permits the input to include at least one of textual data or image data requesting the search query. The operations include: responsive to receiving a particular search input from the user interface, generating one or more search tokens dependent on whether the particular search input includes textual data, image data, or both, each of the one or more search tokens encoding utility asset features represented by the particular search input. The operations include identifying a set of candidate images responsive to the particular search input from a database of images depicting electric grid assets. Identifying the set of candidate images includes comparing the search tokens with textual tokens and image tokens stored in a search index, each textual token representing textual descriptions of utility asset features shared by a respective subset of the images within the database, and each image token representing visual features shared by utility assets depicted in a respective subset of the images within the database. The operations include providing, for display on the user device and within the user interface, the candidate images and positioning at least one candidate image within a respective region of a geographic map of an electric grid that is representative of a geographic location of a particular electrical asset depicted in the at least one candidate image.

In some implementations, the system further includes a machine learning network configured to generate the one or more search tokens, the generating including encoding the utility asset features from the particular search input. The machine learning network can include at least one of (i) a text transformer encoder configured to generate textual embeddings from a clustering of the textual data, or (ii) a vision transformer encoder configured to generate image embeddings from a clustering of the image data.

In some implementations, the operations can include, responsive to receiving the particular search input and the particular search input can include textual data. The operations can include obtaining a representative image relevant to the search input, providing the representative image for display in the user interface and, as additional textual data is received from the user interface, identifying, based on the additional textual data, an object within the representative image corresponding to the additional textual data and providing graphical representations of bounding boxes to surround pixels representing the object within the representative image.

In some implementations, the operations can include obtaining, by one or more scripts and from a data store, utility asset inventory data including at least one of a quantity of the electrical asset for the geographic location, or a quantity of a defect type for the electrical asset; and updating, using the data related to the utility asset, the textual tokens and the image token stored in the search index.

In some implementations, the system includes a first machine learning model configured to generate the search token from the particular search input, and a second machine learning model configured to generate one or more of the textual tokens or the image tokens. The first machine learning model can be a lightweight model relative to the second machine learning model.

In some implementations, the operations further include determining, for each image from a database of images, one or more annotations and one or more bounding boxes. Each annotation is descriptive of a type of utility asset depicted in a respective image and bounded by a particular bounding box. Each bounding box of the one or more bounding boxes encloses a region of image pixels of a respective image that contains at least a portion of a particular utility asset depicted in the respective image. The operations include determining, based on the annotations, a first subset of images from the images that share one or more annotations, and generating, based on the first subset of images and the shared one or more annotations, a textual token representing the first subset of images and storing the textual token in the search index. The textual token includes a first set of utility asset features representative of the annotations shared by each image in the first subset of images and a corresponding identifier for each image in the first subset of images. The operations include determining, based on the image pixels enclosed by the bounding boxes, a second subset of images from the images that share visual features associated with respective utility assets depicted in the respective images. The operations include generating, based on the second subset of images and the shared visual features, an image token representing the second subset of images and storing the image token in the search index. The image token includes an image embedding encoding shared visual features and a corresponding identifier for each image in the second subset of images.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example multi-modal search-based object detection system detecting and providing images of utility assets that match an input query.

FIG. 2 is a diagram of an example multi-modal search-based object detection system displaying images of utility assets on a user interface of a client device.

FIG. 3 is a flowchart illustrating an example process performed by a multi-modal search-based object detection system to build a token-based search index of utility asset images.

FIG. 4 is a flowchart illustrating an example process performed by a multi-modal search-based object detection system to identify and display resulting candidate images based on a search query.

FIG. 5 is a schematic diagram of a computer system.

### DETAILED DESCRIPTION

In general, the disclosure relates to a method, system, and non-transitory, computer-readable medium for performing multi-modal token-based search using images from image databases. Image databases can include numerous (e.g., millions) of images of utility assets, such as utility poles/posts, transformers, network protectors, switches, cables, wires, and other types of electrical equipment. Although image databases include images that capture various classes and defects of electrical equipment, the large volume of images can be difficult to parse for a particular defect type and/or asset class, e.g., to provide all images capturing utility assets with the particular defect type, images capturing utility assets of a particular asset class, or some combination thereof. Therefore, it is difficult to determine patterns or insights from utility asset images to improve electric grid operation, including prioritizing the replacement or refurbishment of the utility asset and identifying assets in an electric grid that match the query.

Searching for images of utility assets in image databases for a particular utility asset class and defect type is difficult due to the large volume of images in the image databases. Each image of a utility asset in the image databases also includes large volumes of feature data, which can be represented in different ways (e.g., keywords, annotations, semantic phrases, and images). The number of asset types, defect types, and number of utility assets deployed in an electrical grid can also contribute to the large volumes of data stored in image databases, therefore it can be difficult to efficiently search for similar images, based on textual and/or image features of an input search query. Therefore, the large volume of images in the image databases and the unique challenge posed by search of utility assets can prevent efficient electric grid operation. The disclosed technology provides efficient object detection and search of images of utility assets from an image database by utilizing offline processes to build a token-based search index and online processing of multi-modal search inputs to query the index.

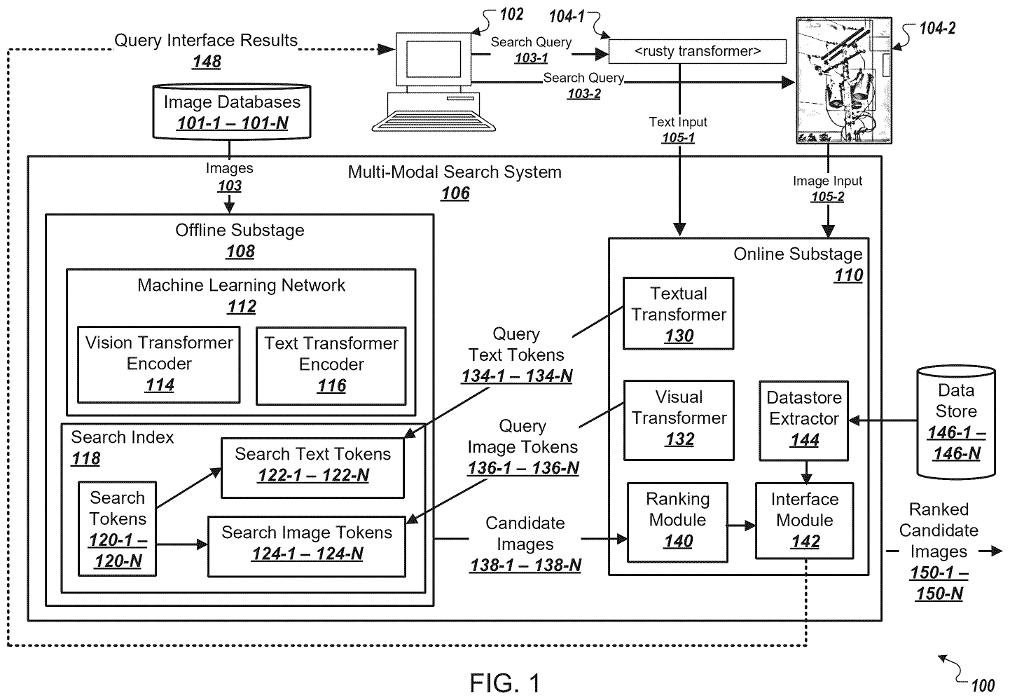

FIG. 1 is a diagram of an example multi-modal search-based object detection system 100 for identifying and providing images of utility assets that match an input query. The multi-modal search-based object detection system 100 includes the multi-modal search system 106, which is configured to obtain images 103 from image databases 101-1-101-N (collectively referred to as “image databases 101”). Each image from the images 103 is an image of a utility asset and includes textual features (e.g., “text features” or “text data”) such as object annotations, e.g., words describing the utility asset in the image, utility asset components, and/or types of defects. Each image also includes visual features (e.g., “image features” or “image data”) that are highlighted by bounding boxes in the image. The bounding boxes in each image describe an enclosed region of pixels in the image that indicate an instance of a utility asset, utility asset component, utility asset defect, or some combination thereof. The annotations and/or the bounding boxes can be manually determined (e.g., human reviewed or tagged), but in some implementations, can be generated by a model, e.g., a machine learning model trained to annotate objects in an image and/or identify objects in an image.

The multi-modal search system 106 includes an offline substage 108 to perform offline processing of the images 103 and generate a token-based search index 118. The search index 118 includes search tokens 120-1-120-N (collectively referred to as “search tokens 120”), each search token 120 including an image identifier that corresponds to a particular image from images 103. A search token in the search tokens 120 is an embedded representation of features from the images 103. For example, a search token can include an identifier for an image, labels of objects represented in the image, and pixel positions in the image for a bounding box that corresponds to an object of the objects represented in the image. The search token can include any number of objects and bounding boxes, and provides a mapping of features (e.g., text features, image features) to a unique image. In some implementations, the search token is a lower dimensional representation (e.g., an embedding and/or encoding) of the features compared to the features of the original input image. In some implementations, the search tokens 120 can be stored in a data repository for the multi-modal search system 106.

The offline substage 108 of the multi-modal search system 106 includes the machine learning network 112 (also referred to as an “image-text model”) that can be configured to generate image tokens and text tokens for each image of the images 103. As depicted in FIG. 1, the machine learning network 112 includes a vision transformer encoder 114 to generate image tokens from image feature data of the images 103 and a text transformer encoder 116 to generate text tokens of the images 103.

The vision transformer encoder 114 can perform a number of embedding and/or encoding processes to map image feature data into a search image token, which can be stored as part of the search image tokens 124-1-124-N (collectively “search image tokens 124”). The vision transformer encoder 114 can be configured to determine a subset of images from the images 103 that share similar visual features (e.g., object class, defect type, or both object class and defect type) based on the bounding boxes of the subset of images. The vision transformer encoder 114 generates an image token representing the subset of images, which are an embedding that encodes the shared visual features. The image token can also be stored in the search index 118 as part of the search image tokens 124 and includes an identifier for each image that share the same visual features. In other words, the image token includes utility asset features represented by the pixel data of the image enclosed in the bounding boxes.

The text transformer encoder 116 can perform a number of embedding and/or encoding processes to map text feature data into a search text token, which can be stored as part of the search text tokens 122-1-122-N (collectively “search text tokens 122”). The text transformer encoder 116 can be configured to determine a subset of images from the images 103 that share similar annotations (e.g., based on object class, defect type, or both object class and defect type) and generate a textual token representing the subset of images. The textual token can also be stored in the search index 118 and includes an identifier for the images that share the same annotations. In other words, the textual token includes utility asset features represented by the annotations.

In some implementations, the machine learning network 112 is fine-tuned to generate tokens from images based on utility asset feature data. In some cases, text tokens can be generated from embeddings by a machine learning network 112 that includes a natural language model, e.g., to process natural language inputs and generate annotations for the image based on the natural language input. In some implementations, the machine learning network 112 includes a binary classifier configured to perform object classification of the image to predict a type of utility asset and/or defect of the utility asset in the image. The inclusion of a binary classifier can provide improved accuracy for the machine learning network 112 prior to generating tokens from the images, by predicting annotations and/or bounding boxes for the image that may not be included in the images 103 from the image databases 101.

In some implementations, the machine learning network 112 can perform a variety of training techniques to improve embedding and encoding of utility asset features from images into tokens. The training techniques can include supervised and unsupervised learning techniques but can also include hybrid-learning techniques. The machine learning network 112 can adjust one or more weights or parameters based on a generated search token. By doing so, the machine learning network 112 can improve its accuracy in encoding features. In some implementations, machine learning network 112 includes one or more fully or partially connected layers. Each of the layers can include one or more parameter values indicating an output of the layers. The layers of the model can generate embeddings of feature vectors from input images, including text annotations and bounding boxes.

The multi-modal search system 106 also includes an online substage 110 configured to process a search input and query the search index 118 for resulting images that match the search input. A client device 102 can provide a number of search queries (e.g., submitted by a user through a peripheral device) to the multi-modal search system 106, such as search query 103-1 and 103-2. The search query 103-1 corresponds to a text input 105-1, and the search query 103-2 corresponds to an image input 105-2. As depicted in FIG. 1, search query 103-1 and text input 105-1 is a string of keywords 104-1 describing a search text input for “rusty transformer”, while search query 103-2 and image input 105-2 is an input image 104-2 of a rusty transformer that optionally includes one or more bounding boxes indicating different objects in the image. The multi-modal search system 106 can receive any number or combination of search inputs. In some implementations, the search input only includes a text input without an image input, or an image input without a text input.

In some implementations, the string of keywords 104-1 is a string of comma separated keywords, although the keywords 104-1 can instead be a semantic input (e.g., words associated with features of the images). In some implementations, the input image 104-2 can include bounding boxes that are entered as part of the query, e.g., a query bounding box indicating a particular portion of the input image 104-2. The query bounding box can also be provided as coordinates corresponding to pixels of the input image 104-2.

The online substage 110 includes a textual transformer 130 to generate one or more query text tokens 134-1-134-N (collectively “query text tokens 134”). Similar to the text transformer encoder 116 of the machine learning network 112 in the offline substage 108, the textual transformer 130 can be configured to generate an encoding and/or embedding of the textual features of the text input 105-1. The online substage 110 also includes a visual transformer 132 to generate one or more query image tokens 136-1-136-N (collectively “query image tokens 136”). Similar to the vision transformer encoder 114 of the machine learning network 112 in the offline substage 108, the visual transformer 132 can be configured to generate an encoding and/or embedding of the visual features of the image input 105-2, based on the bounding boxes (including one or more query bounding boxes) of the image input 105-2.

The online substage 110 of the machine learning network 112 utilizes the query text tokens 134 to identify any matching search text tokens 122 of the search index 118 of the offline substage 108. The identifiers for images from the matching tokens can be used to generate an output indicating candidate images that match the query input. Similarly, the online substage utilizes the query image tokens 136 to identify matching search image tokens 124 of the search index 118 and identifies images that match between the query token and the search index token. A combined list of identifiers for the resulting images can be determined for images in the search index 118 with tokens (e.g., search text tokens 122 and/or search image tokens 124) that match the query token(s), e.g., query text tokens 134 and/or query image tokens 136. The resulting list of identified images can be provided from the offline substage 108 to the ranking module 140 of the online substage 110 as candidate images 138-1-138-N (collectively “candidate images 138”).

The ranking module 140 can be configured to identify a ranking of candidate images 138 based on respective overlap of feature data from tokens of the search index 118. The ranking module 140 determines a ranking of candidate images 138 based on an overlap of textual features and image features from tokens of the query to the tokens of the search index. Images with a substantial degree of overlap in both image and textual features can be ranked higher than images with overlap in one type or mode of input, e.g., textual or visual. In some cases, such as those for a single type or mode of input, the ranking module 140 determines the ranking of images from tokens corresponding to the particular type or mode of input. For example, the ranking module 140 determines a ranking for candidate images 138 based on an overlap of textual feature data of the search text tokens 122 and the query text tokens 134. As another example, the ranking module 140 determines a ranking for candidate images 138 based on an overlap of image feature data of the search image tokens 124 and the query image tokens 136.

The multi-modal search system 106 can be configured to provide ranked candidate images 150-1-150-N (collectively “ranked candidate images 150”) for output, e.g., to the client device 102. In some implementations, the multi-modal search system 106 can provide the ranked candidate images 150 to an interface module 142, which can be configured to generate query interface results 148 for the client device 102. The interface module 142 can be configured to receive data from a datastore extractor 144, which extracts utility data from one or more data stores 146-1-146-N (collectively “data stores 146”). The utility data from the data stores 146 can include an electric grid map, feeder maps and networks, database information, and other types of quantitative or qualitative data related to the electric grid. In some cases, a data store from the data stores 146 can include electrical design specifications for particular types of equipment, such as current rating and voltage rate for a particular type of electrical equipment. The data stores 146 can also include geographical map data, e.g., satellite images or rendered visuals of geographical maps. In some implementations, the datastore extractor includes scripts to retrieve data from the data sources 146.

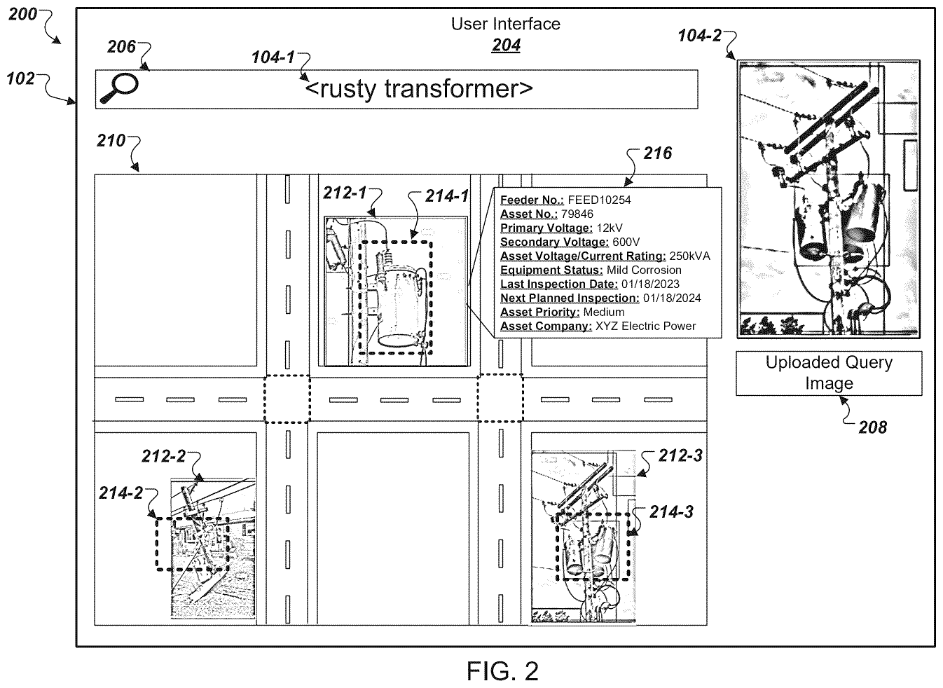

The multi-modal search system 106 utilizes data from the datastore extractor 144 and through the interface module 142 and query interface results 148, generates a user interface for the client device 102. The query interface results 148 can include data that causes the display of the ranked candidate images 150 on a display of the client device 102. In some implementations, the query interface results 148 includes a display of an electrical grid, the ranked candidate images 150, and/or other related electrical asset information obtained by the data store extractor 144. An example user interface is described in reference to FIG. 2 below.

In some implementations, a model (e.g., vision transformer encoder 114) from the machine learning network 112 of the offline substage 108 is more lightweight than a respective model (e.g., visual transformer 132) of the online substage 110. In some implementations, multiple models of the machine learning network 112 (e.g., vision transformer encoder 114, text transformer encoder 116) can be lighter weight than models of the online substage 110 (e.g., visual transformer 132, text transformer 130). In some implementations, a model of the offline substage of the multi-model search system 106 can be trained for a greater amount of time, and/or using more training examples, than a model of the online substage.

For instance, a model is considered to be lighter weight than another model when it is configured to use less computational resources, such as power or computational cycles, to obtain an output from a given input. In some examples, a lighter weight model has fewer parameters, fewer layers, and/or fewer subnetworks relative to a more heavyweight model. The distribution of machine learning tasks between different models can leverage machine learning technology for use on less computationally powerful devices and/or for tasks that require more dynamic output. An example use case for dynamic output can include an output that is responsive to receiving a search input, e.g., from a user through a user interface of a client device.

In some implementations, the search tokens are generated using a first machine learning model. At least one of the textual tokens, the image tokens, or both are generated using a second machine learning model, and the first machine learning model is a lightweight model relative to the second machine learning model.

In some implementations, a first model from the online substage 110 and a second model from the offline substage 108 include knowledge distillation techniques for training the first model and the second model. For example, the second model of the offline substage 108 can be a “teacher model” trained on large training datasets using a deep architecture (e.g., a large language model, a deep learning model). The first model of the online substage 110 can be referred to as a “student model” with a shallow architecture (e.g., relative to the second model of the offline substage 108), and can be fine-tuned from a small training dataset (e.g., relative to the training data for the second model). Furthermore, the student model can be supervised by the teacher model to improve computational resource utilization and search efficiency of the student model. For instance, a first set of training data for a teacher model can include billions of images for training and a second set of training data for a student model can include a smaller scale of images, e.g., millions.

FIG. 2 is a diagram of an example multi-modal search-based object detection system 200 displaying images of utility assets on a user interface 204 of the client device 102 of FIG. 1. The user interface 204 can be an example graphical user interface that includes a search bar 206 for obtaining text inputs such as text input 104-1 (e.g., a string of characters or words representing a text query) and a button 208 for uploading image inputs such as image input 104-2 (e.g., an image with bounding boxes indicating objects in the image). The user interface 204 displays a geographical map 210 of resulting candidate images 212-1-212-3 (collectively “candidate images 212”). Although each candidate image is depicted in FIG. 2 as having a corresponding bounding box (e.g., bounding box 214-1 for candidate image 212-1, bounding box 214-2 for candidate image 212-2, and bounding box 214-3 for candidate image 212-3), any number of bounding boxes can be rendered for a candidate image. The user interface 204 can be updated by providing the query interface results 148 from the multi-modal search system 106, as described in reference to FIG. 1 above.

The user interface 204 shows resulting candidate images that match for one or both of the text input 104-1 and image input 104-2. Each of the candidate images from candidate images 212 can be rendered at a position of the user interface 204 that corresponds to the geographical position of the utility asset captured in the candidate image, relative to the geographical map 210 displayed by the user interface 204. The user interface 204 also includes a window 216 for additional information for the candidate image 212-1, displaying additional data from datastores such as information related to the asset. The information related to the asset can include any connected feeders (e.g., from a feeder map or electric grid utility data), an asset identifier utilized by a utility company, electrical power characteristics such as voltage, current, and any applicable electrical ratings. In some implementations, the information related to the asset depicted through window 216 can include inspection data (e.g., inspection dates and results), any known defects from the electrical utility database or inspection record, a priority for the utility asset, as well as an indicator for the associated utility company for the asset.

The user interface 204 can be configured, based on the query interface results 148, to dynamically update a presentation of a candidate image on the user interface 204. For example, the user interface 204 is configured to dynamically update the presentation of the candidate image with bounding boxes representing the textual search query (e.g., text input 104-1) in the candidate image. In some implementations, a search input for the multi-modal search system 106 can include both a text input 104-1 and an image input 104-2. The user interface 204 can dynamically update a presentation of the image input 104-2 with bounding boxes representing text that is part of the text-input 104-1. In some implementations, the user interface 204 provides the candidate image relevant to the search input (e.g., search index tokens that match the tokens of the search input), in which the search input can include textual data and/or image data. The user interface 204 can receive additional textual data (e.g., additional search input), and the multi-modal search system 106 can identify an object of the candidate image based on the additional textual data. The identified object can correspond to the additional textual data, and the multi-modal search system 106 can identify additional bounding boxes to enclose the object in the candidate image. The user interface 204 can be configured to provide a graphical representation of the additional bounding boxes to enclose pixels in the candidate image that represent the object. Similarly, the additional bounding boxes can be generated for the image input 104-2. For example, the multi-modal search system 106 determines coordinates in the image input 104-2 to generate bounding boxes that enclose pixels representing an object in the image input 104-2 that matches the textual input (e.g., a first instance of text input 104-1, and/or additional textual inputs).

In some implementations, a query entered through a user interface can indicate a query bounding box for search of images in an image database. The multi-modal search system 106 can extract pixel data from the bounding box and the machine learning network 112 can include an object detection model to identify a bounding box indicating an object in the image. The object detection model can determine a bounding box with the largest amount of overlap with respect to a query bounding box entered through the user interface, e.g., a matching bounding box. In some implementations, the query bounding box can be automatically adjusted by the multi-modal search system 106 to improve an overlap of bounding boxes to the query bounding box, e.g., increasing the likelihood of identifying a matching bounding box. The matching bounding box can be a maximum overlapping bounding box and displayed over a query image through a user interface. Furthermore, the pixels of the matching bounding box can be mapped to embeddings using a visual transformer encoder 114 to generate visual tokens from embeddings of the pixels and retrieve similar objects in images of the image database (e.g., search tokens 120) using the visual tokens of a search index.

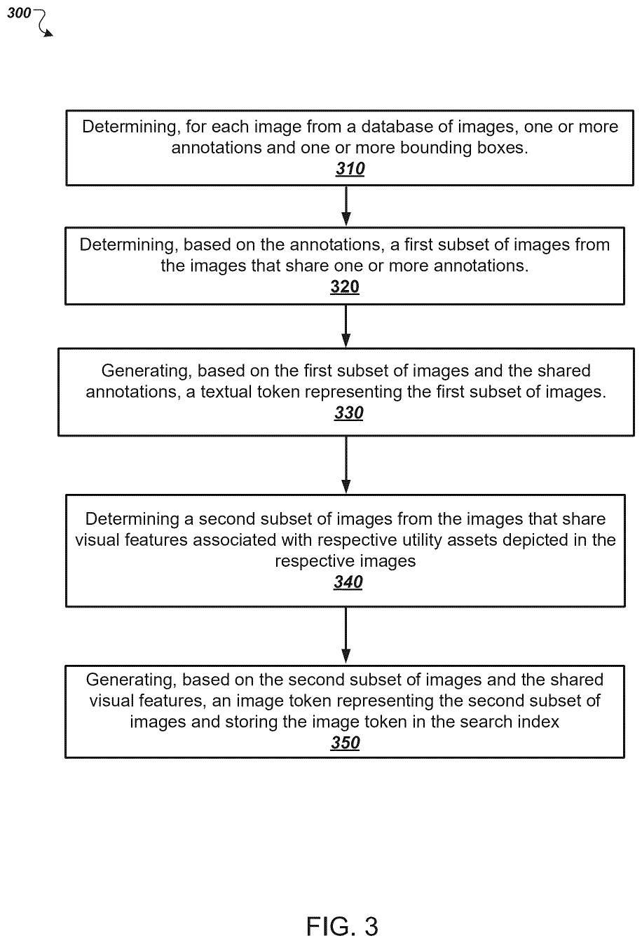

FIG. 3 is a flowchart illustrating an example process 300 performed by a multi-modal search-based object detection system 100 to build a token-based search index (e.g., search index 118) of utility asset images (e.g., images 103). The process 300 can be executed by one or more computing systems including, but not limited to, multi-modal search-based object detection system 100 or multi-modal search system 106, e.g., including an offline substage 108 of the multi-modal search system 106.

The multi-modal search system 106 determines, for each image from a database of images, one or more annotations and one or more bounding boxes (310). Images (e.g., images 103) can be obtained from image databases 101, as described in reference to FIG. 1 above. The annotations for an image can describe a type of a utility asset, asset defect, or utility asset component depicted in the image, and bounded by a bounding box of the image. For example, the annotations correspond to a bounding box that encloses a portion of image pixels in the image and the annotation describing the object represented by the bounding box. The object of the bounding boxes can be any type of electrical equipment, including wires, transformers, utility poles, etc., but can also represent a defect type, e.g., corrosion, fractures, faulty wiring, and other types of damage or defects. In some implementations, the annotations and/or the bounding boxes can be manually included into the image, e.g., human-generated. In some implementations, the images can include annotations and/or bounding boxes that are generated by a model, e.g., a machine learning model trained to generate annotations and/or bounding boxes for objects in images.

The multi-modal search system 106 determines, based on the annotations, a first subset of images that share one or more annotations (320). In some implementations, a first subset of images can be based on annotations for the asset type and/or defect type of the utility asset in each image that are shared for the first subset of images.

The multi-modal search system 106 generates, based on the first subset of images and the shared one or more annotations, a textual token representing the first subset of images (330). The textual token can be stored in a search index, e.g., search index 118 described in reference to FIG. 1 above. The textual token can include a first set of utility asset features representative of the annotations shared by each image in the first subset of images. The textual token also includes a corresponding identifier for each image in the first subset of images. In some implementations, the multi-modal search system 106 includes a machine learning network (e.g., machine learning network 112) configured to generate textual tokens (e.g., search text tokens 122). The machine learning network can include a text transformer encoder (e.g., text transformer encoder 116) trained to generate embeddings of feature data (e.g., representing features of utility asset) based on the annotations.

The embedding of the features representing the shared annotations can be projected in a lower dimensional representation, e.g., relative to the feature data from the images in the first subset of images. In some implementations, the text transformer encoder is configured to generate the embedding based on a clustering of the first set of utility asset features. For example, a multi-modal search system (e.g., by an offline substage of the multi-modal search system 106, by a machine learning network, and/or by the text transformer encoder) can cluster the utility assert features from the shared annotations. In some implementations, the text transformer encoder can be a natural language processing model trained to generate textual tokens based on natural language inputs.

The multi-modal search system 106 determines, based on the image pixels enclosed by the bounding boxes, a second subset of images (340). The second subset of images are determined from the images that share visual features associated with the utility assets represented in the images. In some implementations, the image pixels include pixel data that indicate features that identify an object class and/or a defect type for a utility asset.

The multi-modal search system 106 generates, based on the second subset of images and the shared visual features, an image token representing the second subset of images (350). The image token can include image embedding that encodes shared visual features of the second subset of images. The shared visual features from the second subset of images can be from the pixel data of pixels enclosed in the bounding boxes for the images.

Similar to the text token, the image token can be stored in a search index and includes a corresponding identifier for each image in the second subset of images. In some implementations, the multi-modal search system 106 includes a machine learning network (e.g., machine learning network 112) configured to generate image tokens (e.g., search image tokens 124). For example, the machine learning network can include a vision transformer encoder configured to generate image embeddings from a clustering of the shared visual features. The machine learning network can include a visual transformer encoder (e.g., visual transformer encoder 114) trained to generate embeddings of feature data (e.g., representing features of utility asset) based on the shared visual features. Embeddings of features represented by the shared visual features can be projected in a lower dimensional representation, e.g., relative to the feature data from the images in the second subset of images.

In some implementations, the visual transformer encoder is configured to generate the embedding based on a clustering of the shared visual features of utility assets in the second subset of images. For example, multi-modal search system (e.g., by an offline substage of the multi-modal search system 106, by a machine learning network, and/or by the visual transformer encoder) can cluster the utility assert features from the image pixels enclosed by the bounding boxes. In some implementations, the text transformer encoder can be a natural language processing model trained to generate textual tokens based on natural language inputs.

In some implementations, images can be included in both the first subset of images and the second subset of images. For example, textual and image tokens can be generated for the images that share textual features (e.g., from shared annotations) and image features (e.g., from shared visual features of bounding boxes).

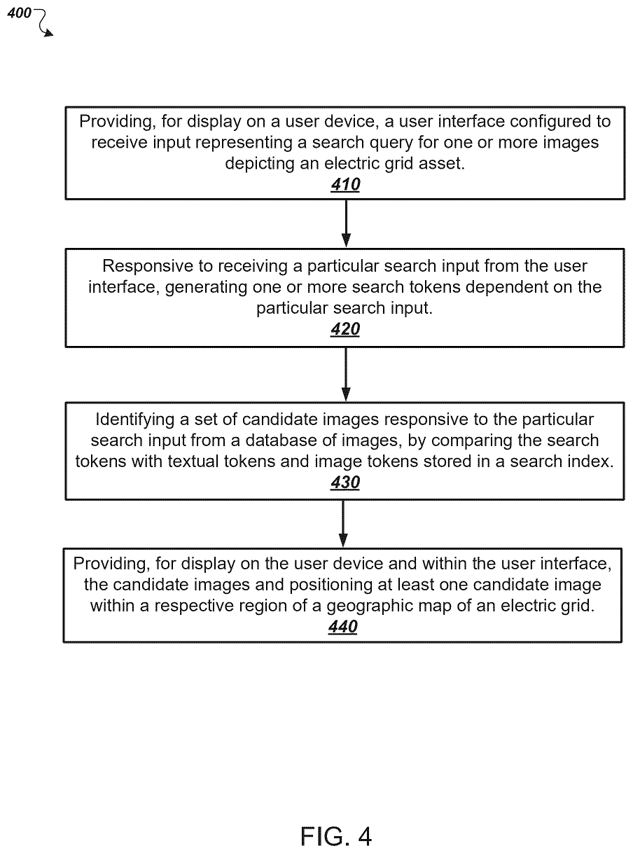

FIG. 4 is a flowchart illustrating an example process 400 performed by a multi-modal search-based object detection system 100 to identify and provide resulting candidate images based on a search input. Process 400 can be executed by one or more computing systems including, but not limited to, the multi-modal search-based object detection system 100 or the multi-modal search system 106, e.g., including an online substage 110 of the multi-modal search system 106.

The multi-modal search system 106 provides, for display on a user device (e.g., client device 102, described in reference to FIG. 1 above), a user interface (e.g., user interface 204, described in reference to FIG. 2 above) configured to receive input representing a search query for one or more images depicting an electric grid asset (410). The user interface permits the input to include at least one of textual data or image data requesting the search query. The user interface can include a search bar (e.g., search bar 206) for a user of a client and/or user device to enter a text input. Examples of textual data (e.g., a text input) can include a keyword, a number of keywords, and/or a semantic phrase of words. The user interface can include an input mechanism (e.g., a button to enter a directory) to upload and submit an image query. In some implementations, the user interface includes a mechanism for entering a query bounding box (e.g., entering coordinates for the boundary box, drawing a bounding box over a portion of the input image) that encloses pixels of the input image to submit as an image query.

In response to receiving a particular search input from the user interface, the multi-modal search system 106 generates one or more search tokens dependent on the particular search input (420). The multi-modal search system 106 generates search text tokens (e.g., search text tokens 122) based on receiving a text input but can also generate search image tokens (e.g., search image tokens 124) based on receiving an image input. The search tokens (search tokens 120) include both search text tokens and search image tokens, and each search token encodes feature data from utility asset features (including annotations and bounding boxes for images of utility assets). In some implementations, the search tokens generated by a machine learning network encode utility asset features from the search input into a lower dimensional space compared to an original dimension of the utility asset features from a text and/or image input. The machine learning network can include a text transformer encoder to generate textual embeddings from a clustering of the textual data from the search input, and/or a vision transformer encoder to generate image embeddings from a clustering of the image data from the search input.

In some implementations, the machine learning network utilized for the online substage of the multi-modal search system 106 is a first machine learning model with a fewer number of parameters, layers, and/or subnetworks, compared to the number of parameters, layers, and/or subnetworks of a second machine learning network utilized for the offline substage. By utilizing a machine learning network with fewer parameters for online processing (e.g., online substage), search results can be more readily retrieved from the search index. Furthermore, the search index built from offline processing (e.g., offline substage) can provide improved accuracy of search tokens for querying, e.g., by a client device. For example, the second machine learning network is a deeper model than the first machine learning model and can be configured to generate accurate, computationally efficient search tokens for the search index.

The multi-modal search system 106 identifies a set of candidate images responsive to the particular search input from a database of images (430). The images (e.g., images 103) from one or more image databases (e.g., image database 101) depict electric grid assets. The multi-modal search system 106 can identify a set of candidate images by comparing search tokens (e.g., a search image token and/or a search text token) to the textual tokens and image tokens stored in a search index, e.g., search index 118. As discussed in reference to FIGS. 1 and 3 above, a textual token represents textual descriptions (e.g., shared annotations) of utility asset features shared by a subset of images within the image database. An image token represents visual features by utility assets (e.g., electric grid assets) depicted in a subset of images within the image database.

The multi-modal search system 106 provides, for display on the user device and within the user interface, the candidate images and positioning at least one candidate image with a respective region of a geographic map of an electric grid (440). The respective region can be representative of a geographic location of a particular electrical asset depicted in the candidate image(s), e.g., at least one candidate image.

In some implementations, the multi-modal search system 106 obtains utility asset inventory data from one or more data stores. The multi-modal search system 106 can utilize scripting tools (e.g., by a datastore extractor 144) to extract the data from the datastores and update search tokens in the search index. For example, data from datastores that include number of utility assets, utility asset ratings, electrical grid maps, feeder maps, geographic maps, and other types of data for the utility assets can be imported to the token, and thus permit updating of encoded values for tokens representing images in the search index.

In some implementations, the multi-modal search system 106 filters images to a subset of images to exclude images that do not contain a text token and/or an image token that matches a query token (e.g., query text token 134, query image token 136) from the search input. In some implementations, the multi-modal search system 106 computes a similarity score indicating a likelihood of an image from the candidate images matching the textual token and the image token from the search input. For example, this can include comparing the tokens of the candidate images to the textual and/or image tokens and comparing the encoded values. A number of candidate images can be identified by their respective similarity scores, by selecting the candidate images with a similarity score greater than a threshold value. In some implementations, multi-modal search system 106 ranks the candidate images based on the similarity score.

In some implementations, the multi-modal search system 106 determines that the search input contains textual data and generates search tokens based on utility asset features from the textual data, omitting any search tokens based on image data. The search tokens based on the textual data can be compared to the textual tokens of the search index. In some cases, the search input can only include textual data. Similarly, the multi-modal search system 106 can determine that the search input contains image data and generates search tokens based on utility asset features (e.g., visual features) from the image data, omitting any search tokens based on textual data. The search tokens based on the image data can be compared to the image tokens of the search index. In some cases, the search input can only include image data, e.g., visual data.

In some implementations, the multi-modal search system 106 receives a particular search input that includes at least textual data and obtains a candidate image that is a representative image relevant to the search input, such as at least one image from the image data. The multi-modal search system 106 can be configured to generate data for a user interface of a device to provide the candidate image for display through the user interface. The multi-modal search system 106 can receive additional textual data through the user interface and identify an object from the candidate image that corresponds to the additional textual data. The object in the candidate image corresponds to the additional textual data, and the multi-modal search system 106 can be configured to generate and provide data that causes the user interface to update the user interface to display a graphical representation of bounding boxes to surround pixels representing the object within the representative image.

In some implementations, displaying the graphical representation can include translating bounding boxes already displayed on the user interface to a different position that encloses the object. In some cases, updating the graphical representation can include adding new bounding boxes to the display that enclose the object. In some implementations, a search input can also include image data (e.g., one or more images) and the representative image from the candidate images includes at least one image from the image data.

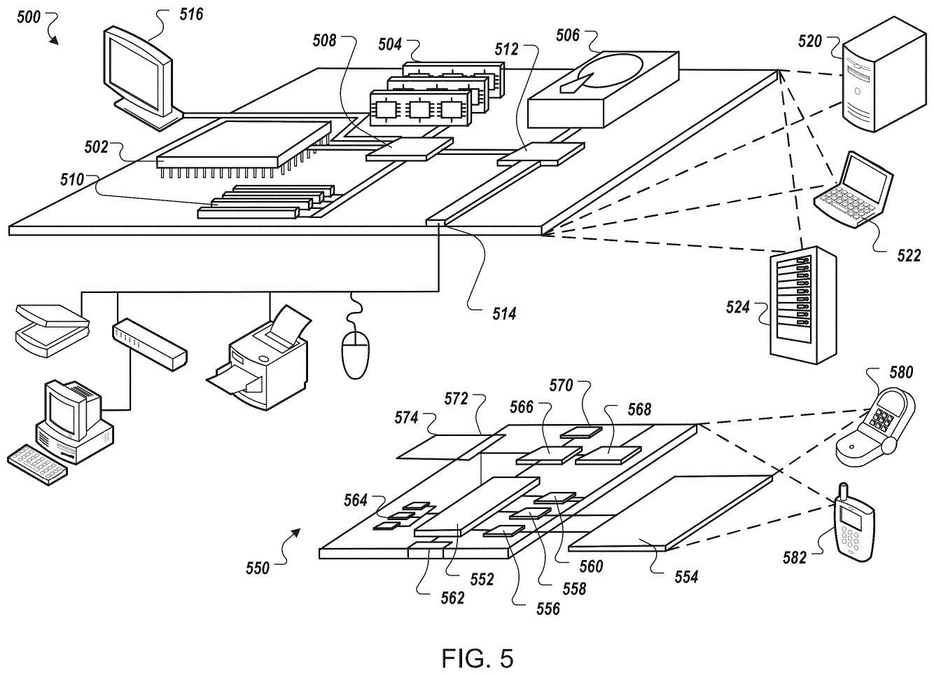

FIG. 5 is a schematic diagram illustrating an example of a computing system used in a multi-modal search-based object detection system. The computing system includes computing device 500 and a mobile computing device 550 that can be used to implement the techniques described herein. For example, one or more components of the multi-modal search-based object detection system 100 or the multi-modal search system 106 can be an example of the computing device 500 or the mobile computing device 550.

The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various buses, and may be mounted on a common motherboard or in other manners as appropriate. The processor 502 can process instructions for execution within the computing device 500, including instructions stored in the memory 504 or on the storage device 506 to display graphical information for a Graphical User Interface (GUI) on an external input/output device, such as a display 516 coupled to the high-speed interface 508. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 502 is a single threaded processor. In some implementations, the processor 502 is a multi-threaded processor. In some implementations, the processor 502 is a quantum computer.

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer-or machine-readable mediums (for example, the memory 504, the storage device 506, or memory on the processor 502). The high-speed interface 508 manages bandwidth-intensive operations for the computing device 500, while the low-speed interface 512 manages lower bandwidth-intensive operations. Such allocation of functions is an example only. In some implementations, the high speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include communication ports (e.g., USB, Bluetooth, Ethernet, wireless Ethernet) that may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device, such as a mobile computing device 550. Each of such devices may include one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may include appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550 or may also store applications or other information for the mobile computing device 550. Specifically, the expansion memory 574 may include instructions to carry out or supplement the processes described above and may include secure information also. Thus, for example, the expansion memory 574 may be provided as a security module for the mobile computing device 550 and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (nonvolatile random access memory). In some implementations, instructions are stored in an information carrier such that the instructions, when executed by one or more processing devices (e.g., processor 552), perform one or more methods, such as those described above. The instructions can also be stored by one or more storage devices, such as one or more computer or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry in some cases. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 3G/4G cellular, among others. Such communication may occur, for example, through the transceiver 568 using a radio frequency. In addition, short-range communication may occur, such as using a Bluetooth, Wi-Fi, or other such transceiver (not shown). In addition, a GPS (Global Positioning System) receiver module 570 may provide additional navigation-and location-related wireless data to the mobile computing device 550, which may be used by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, among others) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively in communication to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache M×Net framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A multi-modal search-based object detection method comprising:
determining, for each image from a database of images, one or more annotations and one or more bounding boxes, wherein each annotation is descriptive of a type of utility asset depicted in a respective image and bounded by a particular bounding box, and wherein each bounding box of the one or more bounding boxes encloses a region of image pixels of a respective image that contains at least a portion of a particular utility asset depicted in the respective image;
determining, based on the annotations, a first subset of images from the images that share one or more annotations;
generating, based on the first subset of images and the shared one or more annotations, a textual token representing the first subset of images and storing the textual token in a search index, wherein the textual token comprises a first set of utility asset features representative of the annotations shared by each image in the first subset of images and a corresponding identifier for each image in the first subset of images;
determining, based on the image pixels enclosed by the bounding boxes, a second subset of images from the images that share visual features associated with respective utility assets depicted in the respective images; and
generating, based on the second subset of images and the shared visual features, an image token representing the second subset of images and storing the image token in the search index, wherein the image token comprises an image embedding encoding shared visual features and a corresponding identifier for each image in the second subset of images.

2. The method of claim 1, wherein at least one image is included in both the second subset of images and the first subset of images.

3. The method of claim 1, wherein the textual token is generated by a machine learning network that comprises a text transformer encoder configured to generate textual embeddings from a clustering of the first set of utility asset features representative of the annotations.

4. The method of claim 1, wherein the image token is generated by a machine learning network that comprises a vision transformer encoder configured to generate image embeddings from a clustering of the shared visual features.

5. A multi-modal electric grid object search method comprising:
providing, for display on a user device, a user interface configured to receive input representing a search query for one or more images depicting an electric grid asset, where the user interface permits the input to include at least one of textual data or image data requesting the search query;
responsive to receiving a particular search input from the user interface, generating one or more search tokens dependent on whether the particular search input comprises textual data, image data, or both, each of the one or more search tokens encoding utility asset features represented by the particular search input;
identifying a set of candidate images responsive to the particular search input from a database of images depicting electric grid assets, where identifying the set of candidate images comprises comparing the search tokens with textual tokens and image tokens stored in a search index, each textual token representing textual descriptions of utility asset features shared by a respective subset of the images within the database, and each image token representing visual features shared by utility assets depicted in a respective subset of the images within the database; and
providing, for display on the user device and within the user interface, the candidate images and positioning at least one candidate image within a respective region of a geographic map of an electric grid that is representative of a geographic location of a particular electrical asset depicted in the at least one candidate image.

6. The method of claim 5, wherein the one or more search tokens are generated by a machine learning network configured to encode the utility asset features from the particular search input, the machine learning network comprising at least one of:
(i) a text transformer encoder configured to generate textual embeddings from a clustering of the textual data; or
(ii) a vision transformer encoder configured to generate image embeddings from a clustering of the image data.

7. The method of claim 5, further comprising:
responsive to receiving the particular search input and wherein the particular search input comprises textual data:
obtaining a representative image relevant to the search input; and
providing the representative image for display in the user interface and, as additional textual data is received from the user interface, identifying, based on the additional textual data, an object within the representative image corresponding to the additional textual data and providing graphical representations of bounding boxes to surround pixels representing the object within the representative image.

8. The method of claim 7, wherein the particular search input comprises image data, and wherein the representative image relevant to the search input comprises at least one image from the image data.

9. The method of claim 7, wherein the search tokens are generated using a first machine learning model,
wherein at least one of the textual tokens, the image tokens, or both are generated using a second machine learning model, and
wherein the first machine learning model is a lightweight model relative to the second machine learning model.

10. The method of claim 5, further comprising:
obtaining, by one or more scripts and from a data store, utility asset inventory data; and
updating, using the data related to the utility asset, the textual tokens and the image token stored in the search index.

11. The method of claim 10, wherein the utility asset inventory data comprises at least one of a quantity of the particular electrical asset for the geographic location, or a quantity of a defect type for the particular electrical asset.

12. The method of claim 5, further comprising:
filtering, based on the textual token and the image token for the input, the images to obtain a filtered subset of images, wherein the filtered subset of images excludes images that do not include at least one token from the textual token and the image token corresponding to the input that match, from the search index, the textual token and the image token;
determining, based on the textual token and the image token, a similarity score for each image in the filtered subset of images, wherein the similarity score indicates a likelihood of a respective image matching the textual token and the image token; and
identifying the candidate images from the filtered subset of images, the candidate images each having a respective similarity score that exceeds a threshold value.

13. The method of claim 12, further comprising:
ranking the candidate images based on the similarity score of the respective candidate image.

14. The method of claim 5, further comprising:
determining that the input comprises the textual data;
in response to determining that the input comprises the textual data, generating the one or more search tokens based on utility asset features from the textual data; and
comparing the one or more search tokens based on the textual data to the textual tokens of the search index.

15. The method of claim 5, further comprising:
determining that the input comprises the image data;
in response to determining that the input comprises the image data, generating the one or more search tokens based on the utility asset features from the image data; and
comparing the one or more search tokens based on the image data to the image tokens of the search index.

16. A system for multi-modal electric grid object search, the system comprising:
one or more computers and one or more storage devices storing instructions that are operable, when executed by the one or more computers, to cause the one or more computers to perform operations comprising:
providing, for display on a user device, a user interface configured to receive input representing a search query for one or more images depicting an electric grid asset, where the user interface permits the input to include at least one of textual data or image data requesting the search query;
responsive to receiving a particular search input from the user interface, generating one or more search tokens dependent on whether the particular search input comprises textual data, image data, or both, each of the one or more search tokens encoding utility asset features represented by the particular search input;
identifying a set of candidate images responsive to the particular search input from a database of images depicting electric grid assets, where identifying the set of candidate images comprises comparing the search tokens with textual tokens and image tokens stored in a search index, each textual token representing textual descriptions of utility asset features shared by a respective subset of the images within the database, and each image token representing visual features shared by utility assets depicted in a respective subset of the images within the database; and
providing, for display on the user device and within the user interface, the candidate images and positioning at least one candidate image within a respective region of a geographic map of an electric grid that is representative of a geographic location of a particular electrical asset depicted in the at least one candidate image.

17. The system of claim 16, wherein the system further comprises a machine learning network configured to generate the one or more search tokens, the generating comprising encoding the utility asset features from the particular search input,
wherein the machine learning network comprises at least one of (i) a text transformer encoder configured to generate textual embeddings from a clustering of the textual data, or (ii) a vision transformer encoder configured to generate image embeddings from a clustering of the image data.

18. The system of claim 16, the operations further comprising:
responsive to receiving the particular search input and wherein the particular search input comprises textual data:
obtaining a representative image relevant to the search input; and
providing the representative image for display in the user interface and, as additional textual data is received from the user interface, identifying, based on the additional textual data, an object within the representative image corresponding to the additional textual data and providing graphical representations of bounding boxes to surround pixels representing the object within the representative image.

19. The system of claim 16, further comprising:
a first machine learning model configured to generate the search token from the particular search input; and
a second machine learning model configured to generate one or more of the textual tokens or the image tokens, and
wherein the first machine learning model is a lightweight model relative to the second machine learning model.

20. The system of claim 19, the operations further comprising:
determining, for each image from a database of images, one or more annotations and one or more bounding boxes, wherein each annotation is descriptive of a type of utility asset depicted in a respective image and bounded by a particular bounding box, and wherein each bounding box of the one or more bounding boxes encloses a region of image pixels of a respective image that contains at least a portion of a particular utility asset depicted in the respective image;
determining, based on the annotations, a first subset of images from the images that share one or more annotations;
generating, based on the first subset of images and the shared one or more annotations, a textual token representing the first subset of images and storing the textual token in the search index, wherein the textual token comprises a first set of utility asset features representative of the annotations shared by each image in the first subset of images and a corresponding identifier for each image in the first subset of images;
determining, based on the image pixels enclosed by the bounding boxes, a second subset of images from the images that share visual features associated with respective utility assets depicted in the respective images; and
generating, based on the second subset of images and the shared visual features, an image token representing the second subset of images and storing the image token in the search index, wherein the image token comprises an image embedding encoding shared visual features and a corresponding identifier for each image in the second subset of images.
